(19) United States
(12) Patent Application Publication
(10) Pub. No.: US 2026/0011797 A1
(43) Pub. Date: Jan. 8, 2026

(54) Early Warning Apparatus and Method for Thermal Runaway of Lithium Iron Phosphate Battery

(71) Applicant: Nanjing Tech University, Nanjing City (CN)

(72) Inventors: Zhirong Wang, Nanjing City (CN); Chaoling Han, Nanjing City (CN); Yawei Lu, Nanjing City (CN)

(21) Appl. No.: 19/184,926

(22) Filed: Apr. 21, 2025

(30) Foreign Application Priority Data
Jul. 8, 2024 (CN) 202410902881.X

(51) Int. Cl. H01M 10/42; G01N 3/08; G01N 29/11; G01N 29/44; G08B 21/18

(52) U.S. Cl. CPC H01M 10/4285; G01N 3/08; G01N 29/11; G01N 29/4418; G01N 29/4472; G08B 21/182; G08B 21/185; H01M 10/4221; G01N 2203/0003; G01N 2291/015; G01N 2291/2698

(57) ABSTRACT

The present invention relates to an early warning apparatus for thermal runaway of a lithium iron phosphate battery, and belongs to the technical field of batteries. The early warning apparatus includes an ultrasonic monitoring module, a stress monitoring module, and an upper computer. The early warning method includes: S1: collecting ultrasonic parameters and stress parameters of the lithium iron phosphate battery; S2: inputting historical data of the collected ultrasonic parameters and stress parameters to a Kalman filtering model to obtain optimal estimation at the time k; S3: computing a comprehensive evaluation parameter J; and S4: judging a warning level according to the comprehensive evaluation parameter. By using the early warning apparatus and method, the ultrasonic parameters can be coupled with the stress parameters so that automatic early warning for the thermal runaway of the lithium iron phosphate battery is achieved.

### TECHNICAL FIELD

The present invention belongs to the technical field of batteries, in particular relates to an early warning apparatus and method for thermal runaway of a lithium iron phosphate battery.

### BACKGROUND ART

A lithium iron phosphate battery is widely applied to various kinds of battery-powered devices due to its high energy density and safety. However, thermal runaway of such a battery may still occur under extreme conditions, which results in serious safety accidents. In most of existing detection technologies, ultrasonic detection or stress parameter monitoring is used alone, by which comprehensive states inside and outside the battery cannot be sufficiently reflected, and the accuracy and timeliness of early warning are lower. The reason is that the variation of single parameter may be interfered by a plurality of factors in a complex environment, resulting in false warning or missed warning. In addition, thermal runaway is resulted from a combined effect of various factors, and by single parameter monitoring, it is difficult to recognize an interaction and a causality among these complex factors.

In recent years, the application research of an ultrasonic technology and a strain sensor technology in battery monitoring is progressively advancing. By detecting internal cracks and defects of the battery by using the ultrasonic technology, real-time information of a health condition of an internal structure of the battery can be provided. By monitoring stress variation of an outer surface of the battery by using the strain sensor technology, an external force bearing condition and structural strain of the battery can be reflected.

The two technologies have respective advantages, but when they are used alone, it is difficult to comprehensively capture the comprehensive state of the battery. Therefore, by using a method for combining ultrasonic detection and strain sensor monitoring to form multi-parameter coupling analysis, the overall health state of the battery can be reflected more accurately, and the accuracy and timeliness of early warning can be improved.

### SUMMARY OF THE INVENTION

By using an early warning apparatus and method for thermal runaway of a lithium iron phosphate battery in the present invention, the thermal runaway of the lithium iron phosphate battery can be early warned based on ultrasonic crack parameter detection and battery outer surface stress parameter coupling.

In order to achieve the above-mentioned object, an early warning apparatus for thermal runaway of a lithium iron phosphate battery in the present invention includes an ultrasonic monitoring module, a stress monitoring module, and an upper computer;
the stress monitoring module is configured to monitor stress parameters of the lithium iron phosphate battery, and includes:
a pressure bearing sheet in contact with one side surface of the lithium iron phosphate battery;
a strain sensor adhered to a surface of a side, away from the lithium iron phosphate battery, of the pressure bearing sheet and capable of achieving electric connection with the upper computer;
two clamping plates respectively labeled as clamping plate A and clamping plate B, the clamping plate A being located on a side, away from the pressure bearing sheet, of the lithium iron phosphate battery and abutting against a corresponding surface of the lithium iron phosphate battery; and the clamping plate B being located on a side, away from the pressure bearing sheet, of the strain sensor and abutting against a corresponding surface of the strain sensor;
a plurality of fixing screws penetrating in the two clamping plates; and
a plurality of groups of nuts in threaded connection to the fixing screws and configured to form an integer from the two clamping plates, the plurality of fixing screws, the strain sensor and the pressure bearing sheet, and the integer abutting against a side of the lithium iron phosphate battery;
the ultrasonic monitoring module is configured to monitor ultrasonic parameters of the lithium iron phosphate battery, and includes:
an ultrasonic probe including an ultrasonic transmitting end and an ultrasonic receiving end; and the ultrasonic receiving end being electrically connected with the upper computer;
an aqueous polymer binder adhered between the ultrasonic transmitting end and the side of the lithium iron phosphate battery;
an ultrasonic signal generator configured to generate ultrasonic waves; and
a power amplifier electrically connected with the ultrasonic signal generator and the ultrasonic transmitting end; and the power amplifier being capable of amplifying the ultrasonic waves and transmitting the ultrasonic waves through the ultrasonic transmitting end.

Further, the pressure bearing sheet covers the side surface of the lithium iron phosphate battery; in this way, once expansion occurs at a certain point of the side, a force will uniformly acts on the pressure bearing sheet.

Further, the strain sensor is located in the middle of the pressure bearing plate, in this way; after being borne by the pressure bearing sheet, the force will be uniformly transmitted to the strain sensor.

Further, the strain sensor is electrically connected with a strain display; and the ultrasonic receiving end is electrically connected with an oscilloscope.

Stress values and ultrasonic values may be reflected intuitively.

Further, an early warning method for thermal runaway of a lithium iron phosphate battery includes the following steps:
S1: continuously collecting ultrasonic parameters and stress parameters of the lithium iron phosphate battery at the same time by an upper computer;
the ultrasonic parameters including an echo amplitude A, an echo frequency F and a crack length L;
the stress parameters including a stress value σ and a strain value ε;
S2: inputting historical data of the ultrasonic parameters and the stress parameters collected in S1 to a Kalman filtering model, and obtaining optimal estimation at the time k by adopting the Kalman filtering model;
S3: computing a comprehensive evaluation parameter J by using the optimal estimation for a state at the time k in S2; and
S4: judging a warning level according to the comprehensive evaluation parameter.

Further, in step S1,
a computational formula of the echo amplitude A is expressed as: A=Vₘₐₓ/V_{ref}; wherein Vₘₐₓ is the maximum value of an echo signal, and V_{ref} is a reference value of the echo signal;
a computational formula of the echo frequency F is expressed as: F=1/T; wherein T is a period of the echo signal;
a computational formula of the crack length L is expressed as: L=V_{wave}/2f; wherein V_{wave} is a propagation speed of ultrasonic waves in a lithium iron phosphate battery material; and f is an ultrasonic frequency; and
a computational formula of the stress value σ is expressed as: σ=E·ε; wherein E is a spring modulus of the lithium iron phosphate battery material; and ε is a strain value and is monitored by a strain sensor.

Further, a formula of the Kalman filtering model is expressed as:

$${\hat{x}}_{k \vert k - 1} = D {\hat{x}}_{k - 1 \vert k - 1} + {Bu}_{k - 1} \qquad ( 1 )$$

wherein \hat{x}_{k|k-1} is a predicted state; \hat{x}_{k-1|k-1} is the current state; D is a state transition matrix,

$$D = [ \begin{matrix}1 & αΔ T & βΔ T & γΔ t & ηΔ t \\ αΔ t & 1 & τΔ t & ηΔ t & γΔ t \\ βΔ t & τΔ t & 1 & τΔ t & βΔ t \\ γΔ t & ηΔ t & τΔ t & 1 & αΔ t \\ ηΔ t & γ Δ t & βΔ t & αΔ t & 1\end{matrix} ] ,$$

α, β, γ, η and τ are respectively coefficients of coupling between the crack length and a stress, an ultrasonic echo amplitude and the stress, the echo frequency and the stress, the crack length and a strain, and the ultrasonic echo amplitude and the strain,

$$α = {C ( \sqrt{π} )}^{m} {\hat{σ}}_{k}^{m} {\hat{L}}_{k}^{m / 2} , β = {C ( \sqrt{π} )}^{m} {\hat{σ}}_{k}^{m} {\hat{L}}_{k}^{m / 2} , γ = {C ( \sqrt{π} )}^{m} {\hat{σ}}_{k}^{m} {\hat{L}}_{k}^{m / 2} ,$$

$$η = C {( \sqrt{π} )}^{m} {\hat{ε}}_{k}^{m} {\hat{L}}_{k}^{m / 2} , τ = {C ( \sqrt{π} )}^{m} {\hat{ε}}_{k}^{m} {\hat{A}}_{k}^{m / 2} ,$$

C and m are constants of the material; B is a control input matrix,

$$B = [ \begin{matrix}0 & 0 \\ \frac{1}{S} & E κ \\ 0 & 0 \\ 0 & 0\end{matrix} ] ,$$

S is a cross sectional area of force bearing, and Eκ is a thermal expansion coefficient of the material; and the optimal estimation of the state at the time k is expressed as:

$${\hat{x}}_{k \vert k} = [ \begin{matrix}{\hat{L}}_{k} \\ {\hat{Λ}}_{k} \\ {\hat{F}}_{k} \\ {\hat{σ}}_{k} \\ {\hat{ε}}_{k}\end{matrix} ] ,$$

and Δt is a time interval of data collection.

Further, a formula of the comprehensive evaluation parameter J is expressed as:

$$J = \frac{{\hat{L}}_{k}}{{P}_{{L}_{k}}} + \frac{{\hat{A}}_{k}}{{P}_{{A}_{k}}} + \frac{{\hat{F}}_{k}}{{P}_{{F}_{k}}} + \frac{{\hat{σ}}_{k}}{{P}_{{σ}_{k}}} + \frac{{\hat{ε}}_{k}}{{P}_{{ε}_{k}}}$$

P_{L}_{ₖ} [symbol] P_{A}_{ₖ} [symbol] P_{F}_{ₖ} [symbol] P_{σ}_{ₖ} and P_{ε}_{ₖ} are diagonal elements of a state covariance matrix Pₖ, and a mean value thereof ranges from 0 to 1.

Further, a division standard for judging the warning level is that:
if J∈[0,50), the warning level is judged as first-level early warning, i.e., a low risk;
if J∈[50,100), the warning level is judged as second-level early warning, i.e., an intermediate risk; and
if J∈[100,+∞), the warning level is judged as third-level early warning, i.e., a high risk.

### Beneficial Effects

By using the apparatus and method, after the ultrasonic parameters are coupled with the stress parameters by using the Kalman filtering model, the optimal estimation for the state at the time k is obtained, then, the comprehensive evaluation parameter is computed according to the optimal estimation, and finally, an early warning standard for the thermal runaway is obtained by means of a value of the comprehensive evaluation parameter, so that automatic early warning for the thermal runaway of the lithium iron phosphate battery can be achieved.

### BRIEF DESCRIPTION OF THE DRAWINGS

FIG. 1 is a schematic diagram of an overall structure of an early warning apparatus;

FIG. 2 is a schematic diagram of a positional relationship among an ultrasonic probe, an aqueous polymer binder, and a lithium iron phosphate battery; and

FIG. 3 is a flow diagram of an early warning method.

1, pressure bearing sheet; 2, strain sensor; 3, clamping plate; 4, fixing screw; 5, nut; 6, strain display; 7, upper computer; 8, ultrasonic transmitting end; 9, ultrasonic receiving end; 10, aqueous polymer binder; 12, ultrasonic signal generator; 13, power amplifier; and 14, oscilloscope.

### DETAILED DESCRIPTION OF THE INVENTION

In order to make objects, technical solutions and advantages of embodiments of the present invention clearer, clear and complete description will be made below to the technical solutions of the present invention in conjunction with the accompanying drawings. Obviously, the described embodiments are a part of the embodiments of the present invention and not all the embodiments. Based on the embodiments of the present invention, all other embodiments obtained by those ordinarily skilled in the art without paying creative work fall within the protection scope of the present invention.

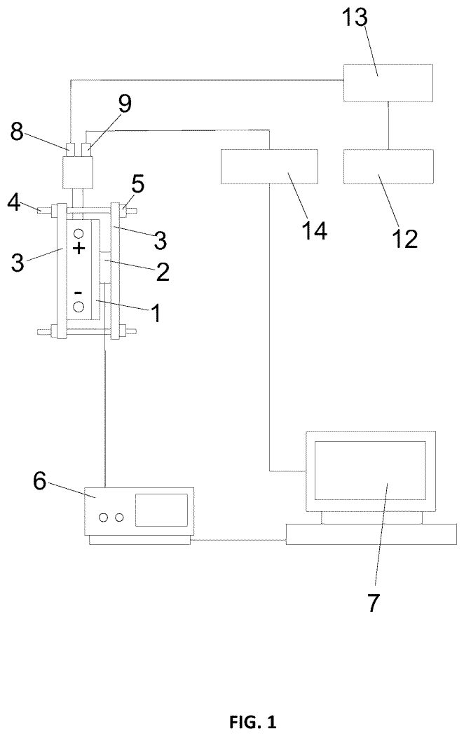

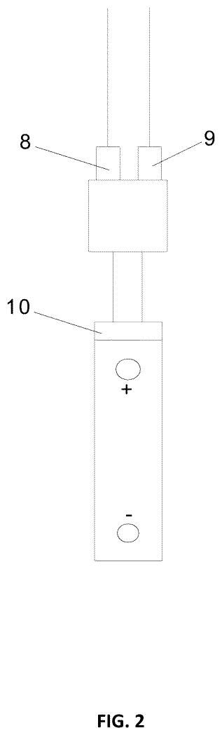

Referring to FIG. 1 and FIG. 2, embodiment 1: an early warning apparatus for thermal runaway of a lithium iron phosphate battery includes an ultrasonic monitoring module, a stress monitoring module, and an upper computer 7.

The ultrasonic monitoring module includes:
a pressure bearing sheet 1 made of stainless steel. In the present embodiment, the pressure bearing sheet 1 being in contact with a side of the lithium iron phosphate battery and covering an entire side surface of the lithium iron phosphate battery; and in the present embodiment, the pressure bearing sheet 1 covering the right side surface of the lithium iron phosphate battery.

A strain sensor 2 adopting a high-precision foil strain gauge and adhered to a surface of a side, away from the lithium iron phosphate battery; of the pressure bearing sheet 1. In the present embodiment, the strain sensor 2 is located in the center of the pressure bearing sheet 1.

Two clamping plates 3 respectively labeled as clamping plate A and clamping plate B; wherein the clamping plate A is located on a side, away from the pressure bearing sheet 1, of the lithium iron phosphate battery and abuts against a corresponding surface of the lithium iron phosphate battery; and the clamping plate B is located on a side, away from the pressure bearing sheet 1, of the strain sensor 2 and abuts against a corresponding surface of the strain sensor 2.

Four fixing screws 4 respectively penetrating in the clamping plate A and the clamping plate B at the same time, wherein the clamping plate A and the clamping plate B are respectively provided with holes allowing fixing blots to penetrate.

Four groups of nuts 5 respectively connected to the fixing screws 4 by using bolts. Each group of nuts 5 including two nuts 5, and the two nuts being respectively in threaded connection to two ends of the corresponding fixing screws 4 and respectively abutting against corresponding surfaces of the clamping plate A and the clamping plate B. The two groups of nuts 5 being configured to form an integer from the two clamping plates 3, two fixing screws 4, the strain sensor 2 and the pressure bearing sheet 1, and the integer abutting against a side of the lithium iron phosphate battery to more accurately reflect the strain variation of the lithium iron phosphate battery.

A strain display 6 electrically connected with the strain sensor 2 and capable of displaying stress data monitored by the strain sensor 2. The upper computer 7 being electrically connected with the strain display 6 and being capable of analyzing the collected stress data.

Referring to FIG. 2, the ultrasonic monitoring module includes:
an ultrasonic probe including an ultrasonic transmitting end 8 and an ultrasonic receiving end 9;
an aqueous polymer binder 10, in the present embodiment, adhered between the ultrasonic transmitting end 8 and an upper surface of the lithium iron phosphate battery. The aqueous polymer binder 10 as an ultrasonic coupling agent being capable of excluding impurity interference between the ultrasonic transmitting end 8 and the upper surface of the lithium iron phosphate battery;
an ultrasonic signal generator 12 configured to generate ultrasonic waves, and a high-sensitivity piezoelectric ultrasonic generator being adopted;
a power amplifier 13 electrically connected with the ultrasonic signal generator 12 and further electrically connected with the ultrasonic transmitting end 8; the power amplifier 13 being capable of amplifying the ultrasonic waves generated by the ultrasonic signal generator 12, and an amplified ultrasonic signal being transmitted through the ultrasonic transmitting end 8;
an oscilloscope 14 electrically connected with the ultrasonic receiving end 9 and configured to display the ultrasonic waves; the upper computer 7 being electrically connected with the oscilloscope 14 and being configured to receive and analyze ultrasonic information.

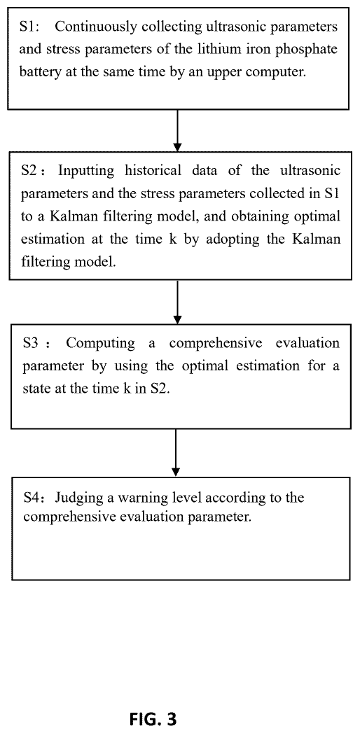

Embodiment 2: referring to FIG. 3, an early warning method for thermal runaway of a lithium iron phosphate battery includes the following steps:

S1: an upper computer continuously collects ultrasonic parameters and stress parameters of the lithium iron phosphate battery at the same time.

A principle of ultrasonic detection is based on propagation properties of sound waves in different materials, and by monitoring the variation of an echo signal, internal cracks or defects may be recognized.

A strain sensor computes a stress value by measuring microscopic deformation of a material under the action of a stress, and is high in sensitivity and precision and capable of reflecting an external force bearing condition of the battery in real time.

The ultrasonic parameters include:
an echo amplitude A obtained by computing a ratio of the maximum value and a reference value of the echo signal, and a computational formula thereof being expressed as:

$$A = {V}_{max} / {V}_{ref} ;$$

wherein Vₘₐₓ is the maximum value of the echo signal and is monitored by an ultrasonic receiving end; and V_{ref} is the reference value of the echo signal and is a given value.

An echo frequency F obtained by computing a period of the echo signal, and a computational formula thereof being expressed as:

$$F = 1 / T ;$$

wherein T is the period of the echo signal and is monitored by the ultrasonic receiving end.

A crack length L obtained based on a propagation speed and frequency of ultrasonic waves in the material, and a computational formula thereof being expressed as:

$$L = {V}_{wave /} 2 f ;$$

wherein V_{wave} is the propagation speed of the ultrasonic waves in a lithium iron phosphate battery material; and f is an ultrasonic frequency.

The stress parameters include:
a relationship between a stress and a strain, the stress parameters being obtained by directly measuring a strain value by the strain sensor and then converting an elasticity modulus of the material into a stress value, and a formula thereof being expressed as:

$$σ = E \cdot ε ;$$

wherein E is a spring modulus of the lithium iron phosphate battery material; and ε is the strain value and is monitored by the strain sensor; and σ is the stress value.

S2: historical data of the ultrasonic parameters and the stress parameters collected in S1 are inputted to a Kalman filtering model, and optimal estimation at the time k is obtained by adopting the Kalman filtering model.

Specifically, a Kalman filtering equation is expressed as:

$${\hat{x}}_{k \vert k - 1} = D {\hat{x}}_{k - 1 \vert k - 1} + {Bu}_{k - 1} \qquad ( 1 )$$

wherein \hat{x}_{k|k-1} is a predicted state, i.e., a predicted state at the time k;
\hat{x}_{k-1|k-1} is the current state, i.e., a state at the time k-1;
D is a state transition matrix and describes how a state of a system transfers from one time step to the next time step, and a coefficient of the state transition matrix may be obtained according to a kinetic equation established based on mechanics of materials and an ultrasonic propagation theory.
B is a control input matrix, and uₖ₋₁ is control input. The control input matrix describes how the control input affects the state of the system. In early warning for thermal runaway of a lithium battery, the control input includes impacts of variation of an externally applied force and temperature on a stress.

In formula (1),

$$\begin{matrix}D = [ \begin{matrix}1 & α Δ t & β Δ t & γ Δ t & ηΔ t \\ α Δ t & 1 & τ Δ t & ηΔ t & γΔ t \\ β Δ t & τΔ t & 1 & τΔ t & βΔ t \\ γΔ t & ηΔ t & τΔ t & 1 & α Δ t \\ ηΔ t & γΔ t & βΔ t & αΔ t & 1\end{matrix} ] , \\ B = [ \begin{matrix}0 & 0 \\ \frac{1}{S} & Ek \\ 0 & 0 \\ 0 & 0\end{matrix} ] ,\end{matrix}$$

wherein α, β, γ, η and τ are respectively coefficients of coupling between the crack length and a stress, an ultrasonic echo amplitude and the stress, the echo frequency and the stress, the crack length and a strain, and the ultrasonic echo amplitude and the strain, and Δt is a time interval of data collection.
S is a cross sectional area of force bearing, and Eκ is a thermal expansion coefficient of the material. In addition,

$$\begin{matrix}α = C {( \sqrt{π} )}^{m} {\hat{σ}}_{k}^{m} {\hat{L}}_{k}^{m / 2} , \\ β = {C ( \sqrt{π} )}^{m} {\hat{σ}}_{k}^{m} {\hat{L}}_{k}^{m / 2} , γ = C {( \sqrt{π} )}^{m} {\hat{σ}}_{k}^{m} {\hat{F}}_{k}^{m / 2} , η = {C ( \sqrt{π} )}^{m} {\hat{ε}}_{k}^{m} {\hat{L}}_{k}^{m / 2} , τ = {C ( \sqrt{π} )}^{m} {\hat{ε}}_{k}^{m} {\hat{A}}_{k}^{m / 2}\end{matrix}$$

Herein, C and m are constants of the material.

An error covariance update equation is expressed as:

$${P}_{kk} = ( I - {K}_{k} H ) {P}_{kk - 1} \qquad ( 4 )$$

I is a unit matrix; Kₖ is a Kalman gain; H is a measurement matrix; Pₖₖ₋₁ is a prediction error covariance; and Pₖₖ is prediction error covariance update;
the Kalman gain is expressed as:

$${K}_{k} = {P}_{kk - 1} {{H}^{T} ( {H}_{Pkk - 1} {H}^{T} + R )}^{- 1} \qquad ( 3 )$$

Pₖₖ₋₁ is a prediction error covariance; R is a measurement noise covariance; and H^{T} represents a transpose of a measurement matrix.

An update equation is expressed as:

$${\hat{x}}_{k \vert k} = {\hat{x}}_{k \vert k - 1} {K}_{k} ( {z}_{k} - H {\hat{x}}_{k \vert k - 1} ) \qquad ( 2 )$$

wherein \hat{x}_{k|k} is an updated state, Kₖ is a Kalman gain, Zₖ is an actually measured value, and H is a measurement matrix; and the actually measured value includes ultrasonic parameters collected by an ultrasonic sensor and stress parameters collected by a stress sensor. The predicted state is corrected by means of the real-time data to obtain more precise current state estimation.

State variables, such as the crack length, the ultrasonic echo amplitude, the ultrasonic echo frequency and the strain, in Kalman filtering provide key information of a dynamic state of a system. By means of prediction and update stages, the Kalman filtering can continuously correct estimated values of these state variables, thereby providing the optimal estimation at the time k of the system, i.e., \hat{x}_{k|k};

$${\hat{x}}_{k \vert k} = [ \begin{matrix}{\hat{L}}_{k} \\ {\hat{A}}_{k} \\ {\hat{F}}_{k} \\ {\hat{σ}}_{k} \\ {\hat{ε}}_{k}\end{matrix} ]$$

S3: a comprehensive evaluation parameter is computed by using the optimal estimation for a state at the time k in S2.

A computational formula of the comprehensive evaluation parameter is expressed as:

$$J = \frac{{\hat{L}}_{k}}{{P}_{{L}_{k}}} + \frac{{\hat{A}}_{k}}{{P}_{{A}_{k}}} + \frac{{\hat{F}}_{k}}{{P}_{{F}_{k}}} + \frac{{\hat{σ}}_{k}}{{P}_{{σ}_{k}}} + \frac{{\hat{ε}}_{k}}{{P}_{{ε}_{k}}} ;$$

P_{L}_{ₖ} [symbol] P_{A}_{ₖ} [symbol] P_{F}_{ₖ} [symbol] P_{σ}_{ₖ} and P_{ε}_{ₖ} are diagonal elements of a state covariance matrix, Pₖ, and a mean value thereof ranges from 0 to 1. The comprehensive evaluation parameter J is configured to evaluate a thermal runaway risk of a battery. At the initial time k=0 of Kalman filtering, an initial state covariance matrix P₀ needs to be given. If there is great uncertainty for the initial state estimation, a greater initial covariance may be set; and otherwise, a less initial covariance is set.

S4: a warning level is judged according to the comprehensive evaluation parameter.

A judgment standard is that:
if J∈[0,50), the warning level is judged as first-level early warning, i.e., a low risk; and the system prompts to perform conventional detection and monitoring;
if J∈[50,100), the warning level is judged as second-level early warning, i.e., an intermediate risk; and the system prompts to take certain prevention measures, such as cooling or deloading; and
if J∈[100,+∞), the warning level is judged as third-level early warning, i.e., a high risk; and the system prompts to immediately stop using the battery and perform replacement or maintenance.

Under the inspiration of the above-mentioned ideal embodiments of the present invention, it is entirely possible for relevant skill in the art to make various alterations and modifications without departing from the technical concept of the present invention according to the above-mentioned description content. The technical scope of the present invention is not limited to the content on the description and has to be determined according to the scope of claims.

1. An early warning apparatus for thermal runaway of a lithium iron phosphate battery, characterized by comprising an ultrasonic monitoring module, a stress monitoring module, and an upper computer;
the stress monitoring module being configured to monitor stress parameters of the lithium iron phosphate battery, and comprising:
a pressure bearing sheet in contact with one side surface of the lithium iron phosphate battery;
a strain sensor adhered to a surface of a side, away from the lithium iron phosphate battery, of the pressure bearing sheet and capable of achieving electric connection with the upper computer;
two clamping plates respectively labeled as clamping plate A and clamping plate B, the clamping plate A being located on a side, away from the pressure bearing sheet, of the lithium iron phosphate battery and abutting against a corresponding surface of the lithium iron phosphate battery; and the clamping plate B being located on a side, away from the pressure bearing sheet, of the strain sensor and abutting against a corresponding surface of the strain sensor;
a plurality of fixing screws penetrating in the two clamping plates; and
a plurality of groups of nuts in threaded connection to the fixing screws and configured to form an integer from the two clamping plates, the plurality of fixing screws, the strain sensor and the pressure bearing sheet, and the integer abutting against a side of the lithium iron phosphate battery;
the ultrasonic monitoring module being configured to monitor ultrasonic parameters of the lithium iron phosphate battery, and comprising:
an ultrasonic probe comprising an ultrasonic transmitting end and an ultrasonic receiving end; and the ultrasonic receiving end being electrically connected with the upper computer;
an aqueous polymer binder adhered between the ultrasonic transmitting end and the side of the lithium iron phosphate battery;
an ultrasonic signal generator configured to generate ultrasonic waves; and
a power amplifier electrically connected with the ultrasonic signal generator and the ultrasonic transmitting end; and the power amplifier being capable of amplifying the ultrasonic waves and transmitting the ultrasonic waves through the ultrasonic transmitting end.

2. The early warning apparatus for the thermal runaway of the lithium iron phosphate battery of claim 1, characterized in that the pressure bearing sheet covers the side surface of the lithium iron phosphate battery.

3. The early warning apparatus for the thermal runaway of the lithium iron phosphate battery of claim 2, characterized in that the strain sensor is located in the middle of the pressure bearing sheet.

4. The early warning apparatus for the thermal runaway of the lithium iron phosphate battery of claim 1, characterized in that the strain sensor is electrically connected with a strain display; and the ultrasonic receiving end is electrically connected with an oscilloscope.

5. An early warning method for thermal runaway of a lithium iron phosphate battery, based on the early warning apparatus for the thermal runaway of the lithium iron phosphate battery of claim 1, comprising the following steps:
S1: continuously collecting ultrasonic parameters and stress parameters of the lithium iron phosphate battery at the same time by an upper computer;
wherein the ultrasonic parameters comprise an echo amplitude A, an echo frequency F, and a crack length L;
wherein the stress parameters comprise a stress value σ and a strain value ε;
S2: inputting historical data of the ultrasonic parameters and the stress parameters collected in S1 to a Kalman filtering model, and obtaining optimal estimation at the time k by adopting the K alman filtering model;
S3: computing a comprehensive evaluation parameter J by using the optimal estimation for a state at time k in S2; and
S4: judging a warning level according to the comprehensive evaluation parameter.

6. The early warning method for the thermal runaway of the lithium iron phosphate battery of claim 5, characterized in that in step S1,
a computational formula of the echo amplitude A is expressed as: A=Vₘₐₓ/V_{ref}; wherein Vₘₐₓ is the maximum value of an echo signal, and V_{ref} is a reference value of the echo signal;
a computational formula of the echo frequency F is expressed as: F=1/T; wherein T is a period of the echo signal;
a computational formula of the crack length L is expressed as: L=V_{wave}/2f; wherein V_{wave} is a propagation speed of ultrasonic waves in a lithium iron phosphate battery material; and f is an ultrasonic frequency; and
a computational formula of the stress value σ is expressed as: σ=E·ε; wherein E is a spring modulus of the lithium iron phosphate battery material; and ε is a strain value and is monitored by a strain sensor.

7. The early warning method for the thermal runaway of the lithium iron phosphate battery of claim 6, characterized in that in step S2,
a formula of the K alman filtering model is expressed as:
$${\hat{x}}_{k \vert k - 1} = D {\hat{x}}_{k - 1 \vert k - 1} + {Bu}_{k - 1} \qquad ( 1 )$$
wherein \hat{x}_{k|k 1} is a predicted state; \hat{x}_{k-1|k-1} is the current state; D is a state transition matrix,
$$D = [ \begin{matrix}1 & α Δ t & β Δ t & γ Δ t & ηΔ t \\ α Δ t & 1 & τ Δ t & ηΔ t & γΔ t \\ β Δ t & τΔ t & 1 & τΔ t & βΔ t \\ γΔ t & ηΔ t & τΔ t & 1 & α Δ t \\ ηΔ t & γΔ t & βΔ t & αΔ t & 1\end{matrix} ] ,$$
α, β, γ, η and τ are respectively coefficients of coupling between the crack length and a stress, an ultrasonic echo amplitude and the stress, the echo frequency and the stress, the crack length and a strain, and the ultrasonic echo amplitude and the strain,
$$α = C {( \sqrt{π} )}^{m} {\hat{σ}}_{k}^{m} {\hat{L}}_{k}^{m / 2} , β = {C ( \sqrt{π} )}^{m} {\hat{σ}}_{k}^{m} {\hat{L}}_{k}^{m / 2} , γ = C {( \sqrt{π} )}^{m} {\hat{σ}}_{k}^{m} {\hat{F}}_{k}^{m / 2} ,$$
$$η = {C ( \sqrt{π} )}^{m} {\hat{ε}}_{k}^{m} {\hat{L}}_{k}^{m / 2} , τ = {C ( \sqrt{π} )}^{m} {\hat{ε}}_{k}^{m} {\hat{A}}_{k}^{m / 2} ,$$
C and m are constants of the material; B is a control input matrix,
$$B = [ \begin{matrix}0 & 0 \\ \frac{1}{S} & Ek \\ 0 & 0 \\ 0 & 0\end{matrix} ] ,$$
S is a cross sectional area of force bearing, and Eκ is a thermal expansion coefficient of the material; and the optimal estimation of the state at the time k is expressed as:
$${\hat{x}}_{k \vert k} = [ \begin{matrix}{\hat{L}}_{k} \\ {\hat{A}}_{k} \\ {\hat{F}}_{k} \\ {\hat{σ}}_{k} \\ {\hat{ε}}_{k}\end{matrix} ] ,$$
and Δt is a time interval of data collection.

8. The early warning method for the thermal runaway of the lithium iron phosphate battery of claim 7, characterized in that in step S3, a formula of the comprehensive evaluation parameter J is expressed as:
$$J = \frac{{\hat{L}}_{k}}{{P}_{{L}_{k}}} + \frac{{\hat{A}}_{k}}{{P}_{{A}_{k}}} + \frac{{\hat{F}}_{k}}{{P}_{{F}_{k}}} + \frac{{\hat{σ}}_{k}}{{P}_{{σ}_{k}}} + \frac{{\hat{ε}}_{k}}{{P}_{{ε}_{k}}} ;$$
P_{L}_{ₖ} [symbol] P_{A}_{ₖ} [symbol] P_{F}_{ₖ} [symbol] P_{σ}_{ₖ} and P_{ε}_{ₖ} are diagonal elements of a state covariance matrix Pₖ, and a mean value thereof ranges from 0 to 1.

9. The early warning method for the thermal runaway of the lithium iron phosphate battery of claim 8, characterized in that a division standard for judging the warning level is that:
if J∈[0,50), the warning level is judged as first-level early warning, i.e., a low risk;
if J∈[50,100), the warning level is judged as second-level early warning, i.e., an intermediate risk; and
if J∈[100,+∞), the warning level is judged as third-level early warning, i.e., a high risk.
